(19) United States
(12) Patent Application Publication
(10) Pub. No.: US 2024/0083390 A1
(43) Pub. Date: Mar. 14, 2024

(54) SYSTEM FOR CLEANING A GLAZED SURFACE OF A MOTOR VEHICLE

(71) Applicant: VALEO SYSTEMES D'ESSUYAGE, La Verriere (FR)

(72) Inventors: Adrien PERET, La Verriere (FR); Maxime BAUDOUIN, La Verriere (FR); Yoann DOLLE, La Verriere (FR); Denis THEBAULT, La Verriere (FR); Giuseppe GRASSO, La Verriere (FR)

(73) Assignee: VALEO SYSTEMES D'ESSUYAGE, La Verriere (FR)

(21) Appl. No.: 18/263,246

(22) PCT Filed: Feb. 1, 2022
(86) PCT No.: PCT/EP2022/052291

§ 371 Date: Jul. 27, 2023

(30) Foreign Application Priority Data
Feb. 1, 2021 (FR) FR2100928

(51) Int. Cl. B60S 1/48; B60S 1/50; B60S 1/54; B60S 1/56

(52) U.S. Cl. CPC B60S 1/485; B60S 1/50; B60S 1/54; B60S 1/56

(57) ABSTRACT

A system for cleaning a glazed surface of a motor vehicle including a liquid-spray cleaning device provided with a storage reservoir for storing cleaning liquid, an alternative cleaning device and a control module configured to selectively control the liquid-spray cleaning device and/or the alternative cleaning device. The cleaning system also includes a data acquisition unit configured to detect a qualitative or quantitative characteristic of the cleaning system, the control module being configured to control the liquid-spray cleaning device and/or the alternative cleaning device according to the qualitative or quantitative characteristic detected.

### TECHNICAL FIELD

The present invention relates to the field of the cleaning of the glazed surfaces of a vehicle. More particularly, the invention relates to driver-assistance systems or vehicle lighting or signaling modules which comprise a detection and/or emission member and a system for cleaning this detection and/or emission member.

### BACKGROUND OF THE INVENTION

Modern vehicles are often equipped with driver-assistance systems, whether to assist the driver during parking maneuvers or when driving in traffic in relation to other vehicles, or to replace the driver in autonomous driving vehicles. Each of these systems has at least one detection and/or emission member making it possible to identify the surroundings of the vehicle, this member being able to consist for example, and non-exhaustively, of a sensor of camera or radar type.

Each detection and/or emission member is configured to acquire a datum relating to the surroundings around the vehicle, through a glazed surface associated with this member, and in this context, the glazed surface is exposed to various types of spray or dirt, which can subsequently adversely affect the reliability of the data acquired. However, and notably when these members are implemented within the scope of an autonomous driving function, irrespective of its degree of autonomy, it is essential for the safety of all road users that the data acquired are reliable.

In such a context, the detection and/or emission members are often equipped with cleaning systems, which may adopt various forms.

It is known practice to clean such glazed surfaces using a device that cleans by spraying liquid, which is a type of cleaning that is particularly effective but requires careful attention to be paid as to the amount of cleaning liquid remaining in the vehicle.

The significant number of detection and/or emission members that may be installed on modern or future vehicles, and for example on autonomous vehicles, and which are needed for performing each of the driver-assistance functions offered on such vehicles, entails the provision of a plurality of liquid-spraying devices and increasing the quantity of liquid which is needed for cleaning all of the detection and/or emission members.

It is also known practice to use alternative cleaning devices that do not require cleaning liquid. These alternative cleaning devices offer the advantage of operating without a reserve of cleaning product, but are nevertheless not suitable for all types of cleaning. By way of example, an alternative cleaning means may consist in spraying compressed air, and the effectiveness of the cleaning achieved by spraying air is not optimal when stubborn dirt is present on the glazed surface.

### SUMMARY OF THE INVENTION

The present invention ensures a compromise between the use of a liquid-spray cleaning device and an alternative cleaning device by proposing a system for cleaning a glazed surface of a vehicle, comprising at least one liquid-spray cleaning device provided with at least one storage reservoir for storing cleaning liquid, the cleaning system further comprising at least one alternative cleaning device and at least one control module configured to selectively control the liquid-spray cleaning device and/or the alternative cleaning device during a cleaning operation, characterized in that the cleaning system comprises a data acquisition unit configured to detect a qualitative or quantitative characteristic of the cleaning system, the control module being configured to control the liquid-spray cleaning device and/or the alternative cleaning device according to said qualitative or quantitative characteristic detected.

Such a cleaning system therefore comprises at least two cleaning devices, one of which is a liquid-spray cleaning device, and which are controlled in such a way as to be able to select which cleaning device is best suited to a given situation. The alternative cleaning device offers the advantage of not being dependent on any reserve of cleaning fluid whatsoever and therefore of being able to be used at will. The liquid-spray cleaning device offers the capacity to clean more effectively than the alternative cleaning device but operates on the proviso that cleaning liquid is present. Thus, the cleaning system according to the invention makes it possible, according to the qualitative or quantitative characteristic detected by the data acquisition unit, to select one or the other of the cleaning devices in order to clean one or a plurality of the glazed surfaces in an optimal manner while ensuring that each of the cleaning devices operates correctly.

According to one feature of the invention, the control module is configured to activate the alternative cleaning device momentarily or continuously according to the qualitative or quantitative characteristic detected. Momentary activation may for example be performed with a view to removing dirt that has been deposited on the glazed surface. Continuous activation on the other hand may be activated as a preventive measure in order to prevent dirt from being deposited on the glazed surface.

According to one feature of the invention, the qualitative or quantitative characteristic detected is a quantity and/or a type of dirt detected on the glazed surface, the control module being configured to momentarily activate the liquid-spray cleaning device or the alternative cleaning device.

In this context, the data acquisition unit is particularly configured to analyze the cleanliness of the glazed surface, whether this be in terms of the quantity of dirt present on the glazed surface or the type of such dirt. Such a data acquisition unit is then formed of at least one data acquisition device comprising video acquisition means and image processing and analysis means.

The type of dirt is a decisive factor in selecting which cleaning device to use. It may, for example, be superfluous to use the liquid-spray cleaning device if the quantity and/or the type of dirt detected on the glazed surface can be removed using the alternative cleaning device, for example if fluid has been deposited in the form of droplets. In that way, it is possible to save the cleaning liquid that is still available for use in later cleaning actions when the dirt is adhering more stubbornly or in greater quantity.

Conversely, if it is detected that the quantity and/or type of dirt can be cleaned off only by spraying liquid, for example if it is an insect, then use of the alternative cleaning device is superfluous. In such a situation, the control module then activates the liquid-spray cleaning device.

According to one feature of the invention, the control module is configured to compare the type of dirt detected against a database and to activate the liquid-spray cleaning device as a priority over activation of the alternative cleaning device when the type of dirt detected corresponds to a stubborn type of dirt. A comparison against a database may be useful so as not to activate the alternative cleaning device needlessly if the dirt is stubborn dirt that cannot be cleaned off effectively using the alternative cleaning device.

According to one feature of the invention, the qualitative or quantitative characteristic detected is a quantity of cleaning liquid remaining within the storage reservoir of the liquid-spray cleaning device, the control module being configured to activate the liquid-spray cleaning device or the alternative cleaning device momentarily or continuously. The objective of basing a decision on the quantity of cleaning liquid that remains is to save this liquid as much as possible so as not to encounter a situation where the storage reservoir is empty. Thus, the lower the quantity of cleaning liquid remaining in the reservoir, the greater the extent to which the control module will tend to favor use of the alternative cleaning device, in order to save on cleaning liquid.

In this context, the data acquisition unit is particularly intended to detect the level of liquid remaining in the storage reservoir, and may notably be formed by at least one data acquisition device of the float type, where the position of the float in the reservoir indicates the level of the remaining liquid, or one data acquisition device of optical type, with means for emitting and receiving waves.

Alternatively, the cleaning system may be set up to prioritize one qualitative or quantitative characteristic over another. The cleaning system may for example first of all check the quantity of cleaning liquid that remains and act according to said quantity, or else may focus on the quantity and/or the type of dirt, and use the best-suited cleaning device without taking the remaining quantity of cleaning liquid into consideration.

According to one feature of the invention, the control module is configured to activate the liquid-spray cleaning device as a priority over activating the alternative cleaning device when the quantity of cleaning liquid remaining in the storage reservoir of the liquid-spray cleaning device is above a first threshold value. Within the meaning of the invention, when the remaining quantity of cleaning liquid is above said first threshold value, that means that there is enough cleaning liquid left for the cleaning system to be able to activate the liquid-spray cleaning device whatever may occur, without the risk of generating shortages of this liquid in the short-term. This then ensures that dirt can be removed effectively without the need to worry about the amount of cleaning liquid remaining in the storage reservoir.

By way of example, the first threshold value may correspond to a reservoir fill percentage, and in this instance to a capacity of 50% of a total volume of the cleaning liquid storage reservoir.

According to one feature of the invention, the control module is configured to momentarily activate the alternative cleaning device as a priority over activating the liquid-spray cleaning device when the quantity of cleaning liquid remaining in the storage reservoir of the liquid-spray cleaning device is comprised between the first threshold value and a second threshold value lower than the first threshold value. Within the meaning of the invention, such a quantity of liquid comprised between these two threshold values means that the quantity of cleaning liquid remaining has not yet reached a critical stage but that it is nevertheless sensible to economize on cleaning liquid.

Thus, rather than using the liquid-spray cleaning device as a priority and systematically, the control module will favor the use of the alternative cleaning device so as to limit the use of the liquid-spray cleaning device and thus conserve the cleaning liquid remaining in the storage reservoir for situations that require the spraying of liquid.

Once again, the second threshold value may correspond to a reservoir fill percentage, and in this instance the second threshold value may for example correspond to a capacity of 20% of a total volume of the cleaning liquid storage reservoir.

In this context, as has just been mentioned, the alternative cleaning device may be used momentarily, for example with a view to removing a piece of dirt that has been deposited on the glazed surface, or a small amount of such dirt.

According to one feature of the invention, the bursts in which the alternative cleaning device is activated have a duration of between 1 second and 3 seconds. It has been determined that this range of durations corresponds to the time needed for the alternative cleaning device to remove dirt. Activating the alternative cleaning device over a shorter period would not be sufficiently effective to clean the glazed surface and, conversely, activation over a longer period would lead to an increased power consumption.

According to one feature of the invention, the control module is configured to command detection of the state of cleanliness of the glazed surface when no burst activation of the alternative cleaning device is generated. Such detection of the state of cleanliness occurring after use of the alternative cleaning device momentarily makes it possible to verify the effectiveness of the cleaning performed by this alternative device, it being appreciated that the presumed effectiveness of this alternative device is lower than that of the device that uses the cleaning liquid. If it has not been effective, namely if dirt remains on the glazed surface for example, the control module may for example implement a further momentary use of the alternative cleaning device, it being appreciated that a further detection of the state of cleanliness will then follow. The control module may also, if the detection of the state of cleanliness of the glazed surface returns results that the cleaning has not been satisfactory, implement the liquid-spray cleaning device in order to favor cleanliness of the glazed surface, even though this will lead to a reduction in the quantity of cleaning liquid remaining in the storage reservoir.

According to one feature of the invention, the control module is configured to activate the alternative cleaning device continuously as a priority over activating the liquid-spray cleaning device when the quantity of cleaning liquid remaining in the storage reservoir of the liquid-spray cleaning device is below the second threshold value. In this situation, the quantity of cleaning liquid remaining is at a critical level. The liquid-spray cleaning device is therefore absolutely no longer used until the storage reservoir has been refilled with cleaning liquid. In order nevertheless to ensure the cleanliness of the glazed surface, the alternative cleaning device is activated continuously. Such activation makes it possible to prevent dirt from becoming deposited on the glazed surface. For example, in the case of an alternative device that blows air toward the glazed surface, activation of the alternative cleaning device makes it possible to generate a barrier between the glazed surface and the external surroundings that prevents dirt from becoming deposited on the glazed surface.

According to one feature of the invention, the qualitative or quantitative characteristic detected is an operational status of the liquid-spray cleaning device, the control module being configured to activate the alternative cleaning device continuously if the liquid-spray cleaning device is operationally defective. In other words, the alternative cleaning device may also be used continuously when the liquid-spray cleaning device cannot be used or when it is able to operate only in a degraded mode with performance deemed to be insufficient. The operational defect with the liquid-spray cleaning device may for example present as a loss of cleaning liquid, a breakdown of the pump used for circulating the cleaning liquid, a malfunctioning of a spray nozzle used for spraying the cleaning liquid, or else degradation of the effectiveness of the cleaning liquid.

According to one feature of the invention, the alternative cleaning device may be a compressed-air cleaning device. Air is blown so as to spray the air onto the glazed surface at a high pressure so as to remove dirt that has been deposited on said glazed surface. The air may for example be compressed using a compression device, and guided toward an electrically operated valve, the opening of which causes compressed air to be sprayed via a suitable spray nozzle.

According to one feature of the invention, the alternative cleaning device is a mechanical and/or electrical cleaning device. As an alternative to a compressed-air cleaning device, the alternative cleaning device may for example be a wiper blade able to wipe the glazed surface or a high-speed rotary casing comprising a transparent surface that covers the surface of the sensor and on which the dirt is liable to be deposited, this dirt then being removed via a centrifugal spinning effect. The alternative cleaning device may also comprise an electromechanical device that removes dirt by deforming the glazed surface or else an electrical device that removes dirt using electrical pulses.

The invention also covers a cleaning method implemented by a system for cleaning a glazed surface as described hereinabove, comprising: a first step during which a qualitative or quantitative characteristic relating to the cleaning system is detected, a second step during which the liquid-spray cleaning device and the alternative cleaning device are controlled according to the qualitative or quantitative characteristic detected.

It should be noted that, in the second step, the control of the two cleaning devices means that these two devices receive an instruction to operate or to stop, and that this does not necessarily mean that the two devices are in operation simultaneously. According to one feature of the method, the first step may be initiated following the detection of dirt on the glazed surface. In other words, the data acquisition device able to detect the dirt is permanently active so as to automatically initiate the cleaning method as soon as dirt is deposited on the glazed surface. However, the cleaning method may be initiated manually by a user of the vehicle, for example by pressing a button.

### BRIEF DESCRIPTION OF DRAWINGS

Further features and advantages of the invention will become more clearly apparent both from the following description and from a number of exemplary embodiments, which are given by way of non-limiting indication with reference to the attached schematic drawings, in which:

FIG. 1 is a front view of a vehicle equipped with a detection and/or emission member and a cleaning system according to the invention configured to clean this detection and/or emission member;

FIG. 2 is a diagram depicting a system for cleaning a glazed surface according to a first embodiment of the invention,

FIG. 3 illustrates a first mode of operation of the cleaning system,

FIG. 4 illustrates a second mode of operation of the cleaning system,

FIG. 5 illustrates a third mode of operation of the cleaning system, and

FIG. 6 illustrates a fourth mode of operation of the cleaning system.

### DETAILED DESCRIPTION OF THE INVENTION

It should be noted that the features, variants and different embodiments of the invention, which will be described in detail hereinafter, may be combined with one another, in various combinations, provided that they are not mutually incompatible or mutually exclusive. In particular, it is possible to imagine variants of the invention that comprise only a selection of features described below, independently of the other features described, if this selection of features is sufficient to confer a technical advantage and/or to differentiate the invention from the prior art.

The description which follows will notably describe one particular embodiment of a system for cleaning a glazed surface according to the invention, which is particular in that the cleaning system comprises a data acquisition unit configured to detect a qualitative or quantitative characteristic of the cleaning system, the control module being configured to control the liquid-spray cleaning device and/or the alternative cleaning device according to said qualitative or quantitative characteristic detected.

This cleaning system will be described more particularly for the case in which the glazed surface consists of the glazed surface of a detection and/or emission member, it being appreciated that everything that will be described could be applied, without departing from the context of the invention, to the cleaning of a glazed surface that contributes to delimiting the passenger compartment of the vehicle, such as a windshield or a rear window of the vehicle.

With reference first of all to FIG. 1, a vehicle 100 may be equipped with a detection and/or emission unit 102 comprising at least one detection and/or emission member 104 and a cleaning system 1 according to the invention, the cleaning system 1 being configured to ensure that the glazed surface here associated with the detection and/or emission member is free of dirt, which is to say here to ensure that the emission/reception field of the detection and/or emission member 104 remains clear so as to allow optimal image acquisition. The detection and/or emission unit 102 may, without preference, here consist either of a data acquisition system in a driver-assistance system of the vehicle 100 or of a lighting module of a lighting and/or signaling system of this vehicle.

The detection and/or emission member 104 is for example an image-capturing optical sensor such as a camera. It can be a CCD (charge-coupled device) sensor or a CMOS sensor including an array of miniature photodiodes. According to another variant, without this list being in any way exhaustive, it may be an infrared-radiation sensor such as an infrared camera, a light emitter such as a headlamp, an optoelectronic device such as an LED (light-emitting diode), an electromagnetic-radiation sensor/emitter such as a lidar (laser imaging, detection and ranging) or a radar (radio detection and ranging) device. According to yet another variant, it may be an acoustic, for example ultrasound radiation, detection and/or emission member.

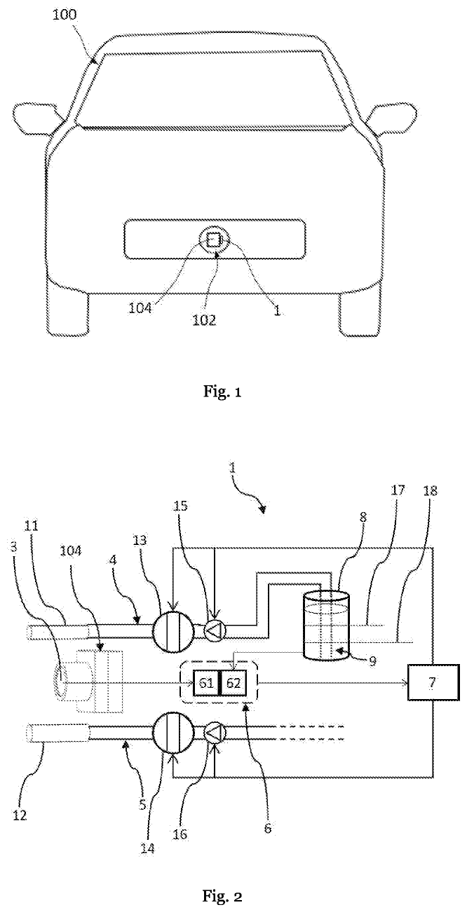

FIG. 2 more particularly illustrates the cleaning system 1 configured for cleaning a glazed surface 3 of an optical sensor that forms the aforementioned detection and/or emission member 104. Correct operation of this sensor is dependent on the cleanliness of the glazed surface 3. The cleaning system 1 is therefore configured to guarantee the permanent cleanliness of the glazed surface 3.

In order to do so, the cleaning system 1 comprises a liquid-spray cleaning device 4 and an alternative cleaning device 5. The cleaning system 1 thus comprises at least two different means for cleaning the glazed surface 3.

The liquid-spray cleaning device 4 extends from a storage reservoir 8 to a first spray nozzle 11. The storage reservoir 8 corresponds to a container for a cleaning liquid 9. The first spray nozzle 11 is positioned in such a way that the cleaning liquid 9 is sprayed against the glazed surface 3.

The liquid-spray cleaning device 4 also comprises, in addition to the storage reservoir 8 and the first spray nozzle 11, a pump 15 and a first electrically operated valve 13. The pump 15 circulates the cleaning liquid 9. The first electrically operated valve 13 is configured to be in an open position so as to allow the cleaning liquid 9 to circulate from the storage reservoir 8 to the first spray nozzle 11, or else in a closed position to block the passage of the cleaning liquid 9 toward the first spray nozzle 11 when there is no need to spray liquid in order to clean the glazed surface.

When the liquid-spray cleaning device 4 is used, the quantity of cleaning liquid 9 remaining within the storage reservoir 8 decreases. The quantity of cleaning liquid 9 remaining is measured by a second data acquisition device 62 which comprises at least a sensor, for example a level sensor of the float type or else an optical sensor, arranged in the storage reservoir and configured to detect data relating to the remaining quantity of liquid, for example in the form of a reservoir fill level. The quantity of cleaning liquid remaining may be defined for example in terms of whether or not it exceeds a first threshold value 17 and a second threshold value 18. These threshold values are notably recorded in a database implemented in a control module 7 or in a data acquisition unit 6. The way in which the liquid-spray cleaning device 4 behaves may thus vary according to the amount of cleaning liquid remaining with respect to these threshold values, the second threshold value 18 being lower than the first threshold value 17. By way of nonlimiting example of the invention, under the condition whereby the second threshold value is lower than the first threshold value, the first threshold value may for example correspond to 50% of the total volume of the storage reservoir 8, and the second threshold value 18 may for example correspond to 20% of the total volume of the storage reservoir 8.

The alternative cleaning device 5, depicted partially here, is, by way of example, a compressed-air cleaning device. Alternatively, the alternative cleaning device 5 may be a wiper blade, a centrifugal-spinning cleaning device, an electromechanical device of piezoelectric type, a device that cleans by activating electrodes, or any other device able to wipe and/or clean the glazed surface 3.

By way of compressed-air cleaning device, the alternative cleaning device 5 comprises a second spray nozzle 12, a second electrically operated valve 14 and a compression device 16. The compression device 16 is able to compress the air and the compressed air may be directed toward the second spray nozzle 12 when the second electrically operated valve 14 is in the open position. The second spray nozzle 12 is configured so that the compressed air can be sprayed toward the glazed surface 3. In FIG. 2, the two electrically operated valves are depicted in the closed position.

The cleaning system 1 also comprises a data acquisition unit 6 configured to detect a qualitative or quantitative characteristic of the cleaning system. This data acquisition unit may comprise one or more data acquisition devices specifically intended for detecting certain characteristics. Without this list being exhaustive and therefore without limiting the invention, these data acquisition devices may notably be able to detect the capacity of the sensors carried on board the vehicle to emit and receive data, or the presence of a sufficient quantity of cleaning liquid in the corresponding cleaning system. As will be appreciated from what follows, the data acquisition unit of the cleaning system may comprise one or more of these data acquisition devices.

The data acquisition unit 6 may notably be formed, as illustrated in FIG. 2, of a data acquisition device, in this instance arbitrarily referred to as first data acquisition device 61, able to detect a level of cleanliness of the glazed surface and notably able to detect dirt that may be deposited on the glazed surface 3 during operation of the vehicle, as well as a data acquisition device, here arbitrarily referred to as second data acquisition device 62, able to detect the quantity of cleaning liquid 9 remaining in the storage reservoir 8. The first data acquisition device 61 may notably comprise image processing means for determining whether the detection and/or emission field of the optical sensor is obstructed.

The cleaning system 1 finally comprises a control module 7. The control module 7 is configured to command the liquid-spray cleaning device 4 and the alternative cleaning device 5.

The control module 7 is able to receive a qualitative or quantitative characteristic coming from the data acquisition unit 6, for example notification that dirt has been deposited on the glazed surface 3 when the data acquisition unit is formed by the first data acquisition device 61, or notification of the quantity of cleaning liquid 9 remaining in the storage reservoir 8, when the data acquisition unit is formed by the second data acquisition device 62. Where applicable, the control module is able to receive several qualitative or quantitative characteristics of the cleaning system, and for example when the data acquisition unit comprises at least the first data acquisition device 61 and the second data acquisition device 62.

Depending on the qualitative and/or quantitative characteristics sent by the data acquisition unit 6, the control module 7 may analyze said qualitative and/or quantitative characteristics and act, on the one hand, on the pump 15 and on the first electrically operated valve 13 so as to allow or prevent the spraying of cleaning liquid by the liquid-spray cleaning device 4 and, on the other hand, on the compression device 16 and on the second electrically operated valve 14 so as to allow or prevent the operation of the alternative cleaning device 5.

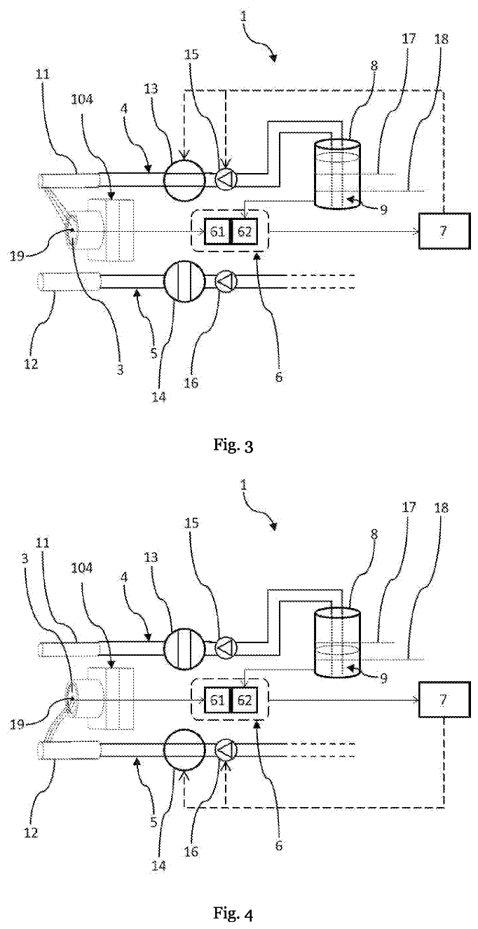

In FIGS. 3 to 6, which illustrate various embodiments of the cleaning system notably dependent on the information received by the control module 7, the command instructions sent by the control module 7 to the liquid-spray cleaning device 4 and to the alternative cleaning device 5 are indicated by the presence or non-presence of arrows and by whether these arrows are drawn in solid line or in broken line. Arrows drawn in solid line indicate activation of one or other of the cleaning devices continuously, while arrows drawn in broken line indicate activation of one or other of the cleaning devices momentarily. Where there is no arrow between the control module and one of the cleaning devices, that indicates that no command instruction is formed or else that no activation of the corresponding cleaning device is demanded, the instruction seeking to keep the cleaning device inactive.

FIG. 3 illustrates a first mode of operation of the cleaning system 1 according to the invention. In FIG. 3, the vehicle is for example moving along and dirt 19 is deposited on the glazed surface 3, thus to the detriment of correct operation of the detection and/or emission member 104.

The dirt 19 is thus detected by the first data acquisition device 61 of the data acquisition unit 6, which sends the qualitative and quantitative characteristics of the dirt 19 to the control module 7, for example the type of dirt 19 and/or the surface area thereof.

In this example, the control module 7 also receives, from the data acquisition unit 6 via the second data acquisition device 62, the quantitative characteristic relating to the storage reservoir 8, namely the quantity of cleaning liquid 9 remaining therein. It should be noted that, in the mode of operation illustrated in FIG. 3, the control module 7 receives qualitative or quantitative characteristics pertaining to the cleaning system, both with regard to the presence of dirt 19 and with regard to the quantity of cleaning liquid 9 remaining in the storage reservoir 8, because of the way the data acquisition unit 6 is configured with two data acquisition devices 61, 62, but it is equally possible for the control module 7 to receive just one or the other of the characteristics of the cleaning system or for the action stemming from receipt of these two characteristics to prioritize one of the characteristics over the other.

In FIG. 3, the quantity of cleaning liquid 9 remaining in the storage reservoir 8 is above the first threshold value 17. This quantitative characteristic therefore indicates that the liquid-spray cleaning device 4 can be used to clean the glazed surface 3 without the risk of generating a shortage of cleaning liquid in the short-term. In that context, the control module 7 activates the liquid-spray cleaning device 4 as a priority, generating an instruction to command the pump 15 and an instruction to command the first electrically operated valve 13 so as to momentarily spray cleaning liquid 9 onto the glazed surface 3. More specifically, the command instructions that are thus generated make it possible, for a given length of time, for example for a few seconds, to run the pump 15 and switch the first electrically operated valve 13 into the open position so that the cleaning liquid can circulate as far as the first spray nozzle 11 and be sprayed against the glazed surface 3 so as to remove the dirt 19 from the glazed surface 3 and thus render the detection and/or emission member 104 operational again.

FIG. 4 is an illustration of a second mode of operation of the cleaning system 1, which differs from the first mode of operation described hereinabove notably in that the quantity of cleaning liquid 9 remaining in the storage reservoir 8 is below the first threshold value 17 and above the second threshold value 18.

According to the abovementioned examples, in FIG. 4 the quantity of cleaning liquid 9 remaining in the storage reservoir 8 is between 20% and 50% of the total volume of this reservoir. Such a configuration means that it is still conceivable to use the liquid-spray cleaning device 4 but that it is nevertheless necessary to contrive to use the alternative cleaning device 5 as far as possible in order to avoid, in the short-term, running into a situation in which there is a shortage of cleaning liquid.

Nevertheless, it is necessary to remove the dirt 19 that has been deposited on the glazed surface 3. In the example illustrated, the data acquisition unit 6 transmits the characteristics pertaining to the presence of dirt 19 to the control module 7 as well as transmitting the quantity of cleaning liquid 9 remaining in the storage reservoir 8. If the control module 7 determines that the dirt can be cleaned off using the alternative cleaning device 5, for example after comparing the characteristics of the dirt 19 with a database, not illustrated, which may be loaded into the memory of the control module 7 or of the data acquisition unit 6, the control module 7 activates the alternative cleaning device 5 as a priority, by generating a command instruction to momentarily activate the compression device 16 and to open the second electrically operated valve 14 so as to send a jet of compressed air onto the glazed surface 3, for example for 1 second to 3 seconds.

The activation of the alternative cleaning device 5 by the control device is accompanied by an additional step of detecting the presence of dirt 19 so as to ensure that the dirt has indeed been removed.

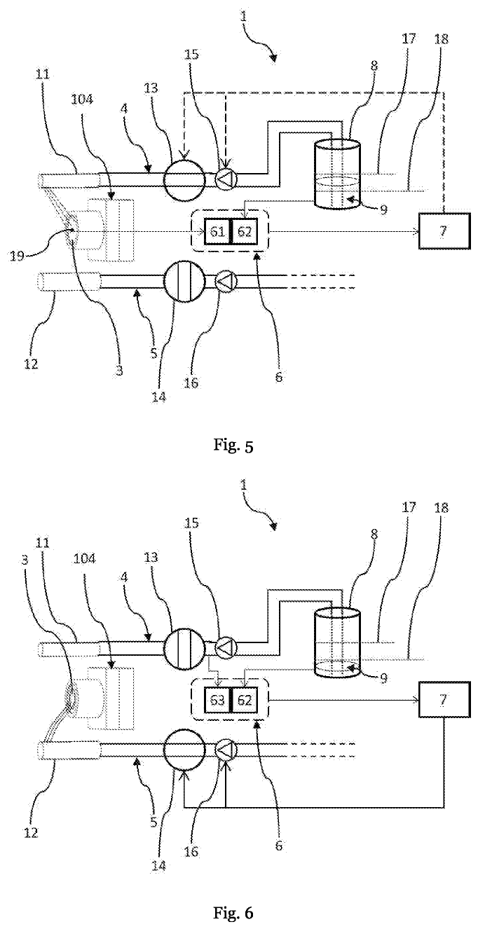

Assuming that this additional detection step identifies that dirt 19 is still present despite the emission of the jet of compressed air, or else if the characteristics relating to the dirt 19 have been interpreted by the control module 7 as being associated with a stubborn type of dirt, the cleaning system 1 may behave in accordance with a mode of operation as illustrated in FIG. 5.

In FIG. 5, the control module 7 activates the liquid-spray cleaning device 4 as described in FIG. 3, this being despite the fact that the quantity of cleaning liquid 9 remaining in the storage reservoir 8 is comprised between the first threshold value 17 and the second threshold value 18, as the essential objective is to ensure correct operation of the detection and/or emission member 104.

In a variant which has not been illustrated, the data acquisition unit of the cleaning system according to the invention comprises only a device for the acquisition of data relating to the level of cleaning liquid remaining in the storage reservoir 8 and no provision is made for the data acquisition unit of the cleaning system to be equipped with a device for the acquisition of data relating to the presence of dirt on the glazed surface. In this variant, priority activation by the control module 7 of the liquid-spray cleaning device 4 or of the alternative cleaning device 5 is dependent only on the quantity of liquid in the storage reservoir. If the quantity of cleaning liquid remaining in the storage reservoir of the liquid-spray cleaning device is above the first threshold value 17, the control module generates instructions to activate the liquid-spray cleaning device 4 as a priority over activating the alternative cleaning device 5. Further, if the quantity of cleaning liquid remaining in the storage reservoir is comprised between the first threshold value 17 and the second threshold value 18, the control module 7 generates an instruction to momentarily activate the alternative cleaning device 5 as a priority over activating the liquid-spray cleaning device 4.

FIG. 6 illustrates another mode of operation when the quantity of cleaning liquid 9 remaining in the storage reservoir 8 is below the second threshold value 18. In this situation, the level of cleaning liquid 9 is critical. It is therefore absolutely essential to avoid using the liquid-spray cleaning device 4 until the storage reservoir 8 has been refilled with cleaning liquid 9.

After having received this quantitative characteristic relating to the storage reservoir 8 via the data acquisition unit 6, the control module 7 activates the alternative cleaning device 5 as a priority, and in this instance continuously, by keeping the compression device 16 running and the second electrically operated valve 14 in the open position over a long period of time. What is meant here by a long period of time is that the duration of activation of the alternative cleaning device in this mode of operation illustrated in FIG. 6 is first and foremost a duration longer than the duration of activation by bursts mentioned previously. More specifically, this long duration may be such that activation of the alternative cleaning device continues until the vehicle next stops. In this way, air is continuously expelled from the second spray nozzle 12 toward the glazed surface 3. The objective here is to activate the alternative cleaning device 5 preventively so as to limit the risk of dirt being deposited on the glazed surface 3 and the risk of this dirt being stubborn and requiring the spraying of liquid during this period of shortage. The continuous jet of air thus acts as a barrier to the glazed surface 3.

Activation of the alternative cleaning device 5 may also be performed in a context that is independent of the quantity of cleaning liquid 9 remaining in the storage reservoir 8, namely according to a state of operation of the liquid-spray cleaning device 4. Thus, the control module 7 may receive, from the data acquisition unit 6 and more particularly here from an additional data acquisition device 63 that forms part of the data acquisition unit and is associated with one or the other of the components of the liquid-spray cleaning device 4, a qualitative characteristic relating to an operational defect with the liquid-spray cleaning device 4 that prevents the latter from being activated. Such an operational defect may, for example, be a leak, a breakdown of the pump 15, a blockage of the first spray nozzle 11 or degradation of the quality of the cleaning liquid 9. Under one of these conditions, the liquid-spray cleaning device 4 is unusable and the control module 7 therefore activates the alternative cleaning device 5 continuously so as to mitigate the effect of the operational defect of the liquid-spray cleaning device 4.

Of course, the invention is not limited to the examples that have just been described and numerous modifications can be made to these examples without departing from the scope of the invention.

The invention, as has just been described, does indeed achieve its stated objective, and makes it possible to propose a system for cleaning a glazed surface that ensures optimal cleaning while at the same time economizing on cleaning liquid. Variants that have not been described here may be implemented without departing from the context of the invention provided that, in accordance with the invention, they comprise a cleaning system according to the invention, namely one able to detect information relating to correct operation of the cleaning system and therefore able to implement different cleaning devices that form part of this cleaning system.

What is claimed is:

1. A system for cleaning a glazed surface of a vehicle, comprising a liquid-spray cleaning device provided with at least one storage reservoir for storing cleaning liquid, at least one alternative cleaning device and at least one control module configured to selectively control the liquid-spray cleaning device and/or the alternative cleaning device during a cleaning operation, wherein the cleaning system includes a data acquisition unit configured to detect a qualitative or quantitative characteristic of the cleaning system, the control module being configured to control the liquid-spray cleaning device and/or the alternative cleaning device according to the qualitative or quantitative characteristic detected.

2. The cleaning system as claimed in claim 1, wherein the control module is configured to activate the alternative cleaning device momentarily or continuously according to the qualitative or quantitative characteristic detected.

3. The cleaning system as claimed in claim 2, wherein the qualitative or quantitative characteristic detected is a quantity and/or a type of dirt detected on the glazed surface, the control module being configured to activate the liquid-spray cleaning device or the alternative cleaning device momentarily.

4. The cleaning system as claimed in claim 2, wherein the qualitative or quantitative characteristic detected is a quantity of cleaning liquid remaining within the storage reservoir of the liquid-spray cleaning device, the control module being configured to activate the liquid-spray cleaning device or the alternative cleaning device momentarily or continuously.

5. The cleaning system as claimed in the preceding claim claim 4, wherein the control module is configured to activate the liquid-spray cleaning device as a priority over activating the alternative cleaning device when the quantity of cleaning liquid remaining in the storage reservoir of the liquid-spray cleaning device is above a first threshold value.

6. The cleaning system as claimed in claim 5, wherein the control module is configured to momentarily activate the alternative cleaning device as a priority over activating the liquid-spray cleaning device when the quantity of cleaning liquid remaining in the storage reservoir of the liquid-spray cleaning device is comprised between the first threshold value and a second threshold value lower than the first threshold value.

7. The cleaning system as claimed in claim 6, wherein the control module is configured to activate the alternative cleaning device continuously as a priority over activating the liquid-spray cleaning device when the quantity of cleaning liquid remaining in the storage reservoir of the liquid-spray cleaning device is below the second threshold value.

8. The cleaning system as claimed in claim 2, wherein the qualitative or quantitative characteristic detected is an operational status of the liquid-spray cleaning device, the control module being configured to activate the alternative cleaning device continuously if the liquid-spray cleaning device is operationally defective.

9. The cleaning system as claimed in claim 1, wherein the alternative cleaning device is a compressed-air cleaning device.

10. A method for cleaning a glazed surface, implemented by a cleaning system with a liquid-spraying cleaning device and an alternative cleaning device, comprising:
detecting a qualitative or quantitative characteristic relating to the cleaning system, and
controlling the liquid-spray cleaning device and the alternative cleaning device according to the qualitative or quantitative characteristic.
